(19) United States
(12) Patent Application Publication
(10) Pub. No.: US 2010/0154116 A1
(43) Pub. Date: Jun. 24, 2010

(54) WHEELCHAIR TRANSFER DEVICE

(76) Inventor: Yu-Yen Fan, Taipei (TW)

Correspondence Address: SCHMEISER OLSEN & WATTS, 18 E UNIVERSITY DRIVE, SUITE # 101, MESA, AZ, 85201, US

(21) Appl. No.: 12/343,925

(22) Filed: Dec. 24, 2008

(51) Int. Cl. A61G 7/10

(52) U.S. Cl. 5/86.1; 5/83.1; 280/250.1

(57) ABSTRACT

A wheelchair transfer device comprises a base frame, an elevation unit and a transfer unit, whereby a caregiver can easily and fast move the disabled person from the wheelchair to the bed or from the bed to the wheelchair. The elevation unit has a moving component that can ascend or descend. On the top of the moving component is a seat pad having an upper seat body and a lower seat body. A transfer unit with a positioning unit is arranged at the bottom of the upper seat body. Track levers are arranged on two sides of the positioning unit. The track levers can extend and retract and allows the upper seat body to slide thereon. Thereby, the caregiver can easily and fast move the disabled person to or from the wheelchair without lifting the disabled person manually and laboriously.

### BACKGROUND OF THE INVENTION

1. Field of the Invention

This invention relates to a wheelchair transfer device, which comprises a base frame, an elevation unit and a transfer unit, whereby a caregiver can easily and fast move the disabled from the wheelchair to another place or from another place to the wheelchair without lifting the disabled manually and laboriously.

2. Description of the Related Art

We all survive on air, water and food, but we cannot avoid aging and sickness, which will eventually disable us. A wheelchair enables a disabled person to move himself and go around. However, the wheelchair cannot move the user to his bed or a sofa where the user can sleep or has a more comfortable space to relax. In such a case, the disabled person always needs help from another. For example, a caregiver holds the disabled in their arms to the bed. However, the caregiver may hurt himself when moving the disabled. Alternatively, the disabled may use an auxiliary instrument, such as a walking stick or an auxiliary walking device, to help himself. However, a disabled person is usually too weak to support himself and walk stably, and may even stumble over a barrier. Therefore, a disabled person or a caregiver confronts many inconveniences when the disabled person moves or is moved from the wheelchair to another place.

Based on many years' experience in related fields, the Inventor has been persistently devoted to researches and experiments and finally proposes the present invention to solve the inconveniences faced by disabled persons and caregivers and improve their situation.

### SUMMARY OF THE INVENTION

The primary objective of the present invention is to provide a wheelchair transfer device, whereby a caregiver can easily and fast move the disabled person from the wheelchair to another place or from another place to the wheelchair.

To achieve the abovementioned objective, the present invention proposes a wheelchair transfer device, which comprises a base frame, an elevation unit and a transfer unit. Two wheels are arranged on two sides of the base frame. A support structure is arranged in between the two wheels. Two auxiliary wheels are arranged on the front side of the base of the support structure. Two position-adjustable handlebars are arranged in the back of the support structure. The elevation unit is arranged in between the wheels of the base frame. The elevation unit has a moving component able to ascend and descend. The elevation unit may be a pneumatic cylinder or a hydraulic cylinder, which is able to raise or lower the moving component. A seat pad is arranged on the top of the moving component and has an upper seat body and a lower seat body. A stopper is arranged on one side of the upper seat body. The transfer unit is arranged in the bottom of the upper seat body and has a positioning unit. Two ends of the positioning unit connect to two track levels. Two casings of the two track levels are fixed inside the lower seat body. The track levels can be pulled out from the casings to a bed or pushed from a bed back to the casings, and the upper seat body can slide on the track levels, whereby a caregiver can easy and quickly move a disabled person sitting on the upper seat body without lifting the disabled manually and laboriously.

It should be noted that the foregoing schematic description and the following detailed description of the present invention is only to exemplify the present invention but not to limit the scope of the present invention.

### BRIEF DESCRIPTION OF THE DRAWINGS

FIG. 1 is a perspective view of a wheelchair transfer device according to the present invention;

FIG. 2 is another perspective view of the wheelchair transfer device according to the present invention;

FIG. 3 is a first diagram schematically showing the operation of the wheelchair transfer device according to the present invention;

FIG. 4 is a second diagram schematically showing the operation of the wheelchair transfer device according to the present invention;

FIG. 5 is a third diagram schematically showing the operation of the wheelchair transfer device according to the present invention; and

FIG. 6 is a fourth diagram schematically showing the operation of the wheelchair transfer device according to the present invention.

### DETAILED DESCRIPTION OF THE INVENTION

Below, the embodiments of the present invention are described in cooperation with the attached drawings. An identical numeral used in the description should direct to the identical or similar elements in the drawings.

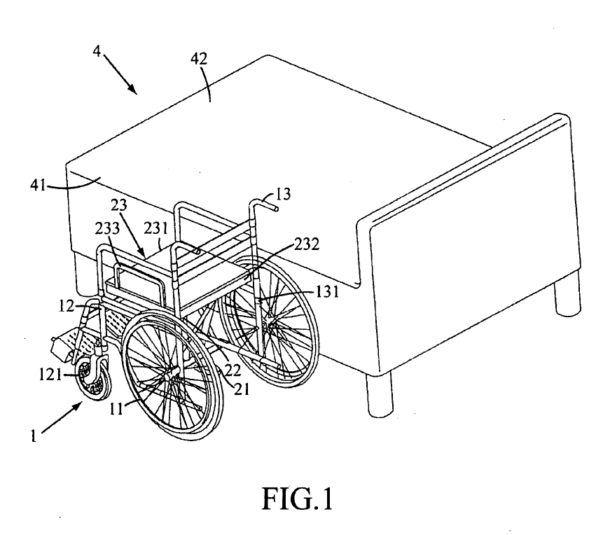

Referring to FIGS. 1-6, the wheelchair transfer device of the present invention comprises a base frame 1, an elevation unit 2 and a transfer unit 3. Two wheels 11 are arranged on two sides of the base frame 1. A support structure 12 is arranged in between the two wheels 11. Two auxiliary wheels 121 are arranged on the front side of the base of the support structure 12. Two position-adjustable handlebars 13 are arranged in the back of the support structure 12. At least one shank switch 131 is arranged in the middle of the position-adjustable handlebar 13 and used to raise or lower the position-adjustable handlebars 13.

The elevation unit 2 is arranged in between the wheels 11 of the base frame 1 and in the center of the support structure 12. The elevation unit 2 has a moving component 22 able to ascend and descend. The elevation unit 2 also has a control valve 21 used to control the moving component 22 to ascend or descend. A seat pad 23 is arranged on the top of the moving component 22 and has an upper seat body 231 and a lower seat body 232. A stopper 233 is arranged on one side of the upper seat body 231. The transfer unit 3 is arranged in the bottom of the upper seat body 231 and has a positioning unit 31. Two ends of the positioning unit 31 connect to two track levels 32. Two casings of the two track levels 32 are fixed inside the lower seat body 232. The track levels 32 can be pulled out from or pushed into the casings thereof, and the upper seat body 231 can slide on the track levels 32.

The disabled can be seated comfortably on seat pad 23 and displaced via the wheelchair transfer device formed of the abovementioned base frame 1, elevation unit 2 and transfer unit 3. The elevation unit 3 may be a pneumatic cylinder, a hydraulic cylinder, an elevation screw, or a rack-and-pinion mechanism, which is able to raise or lower the moving component 22.

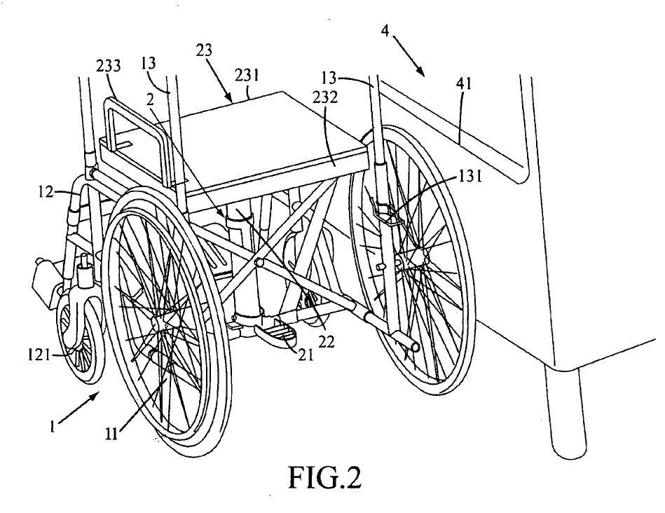

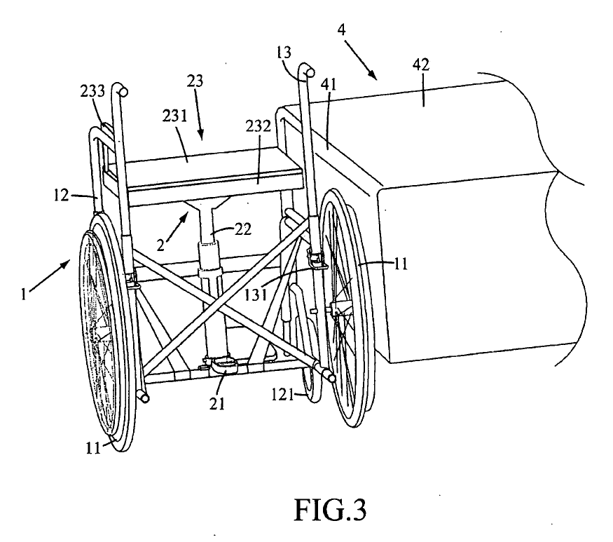

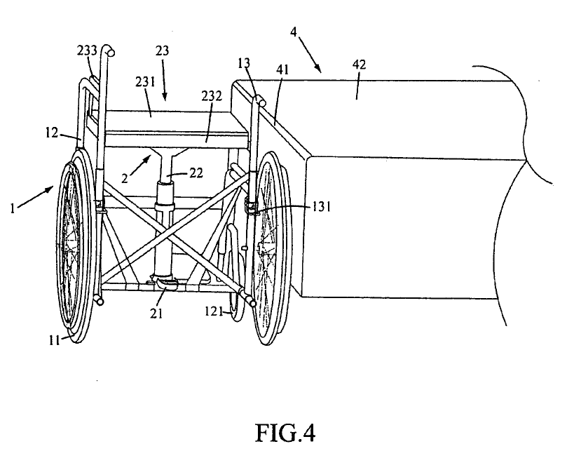

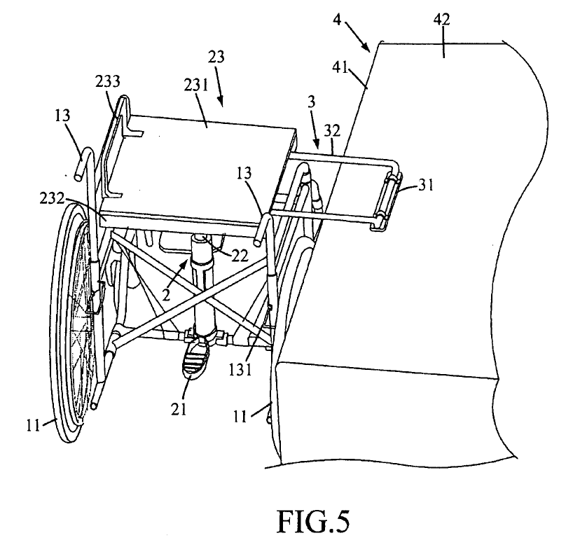

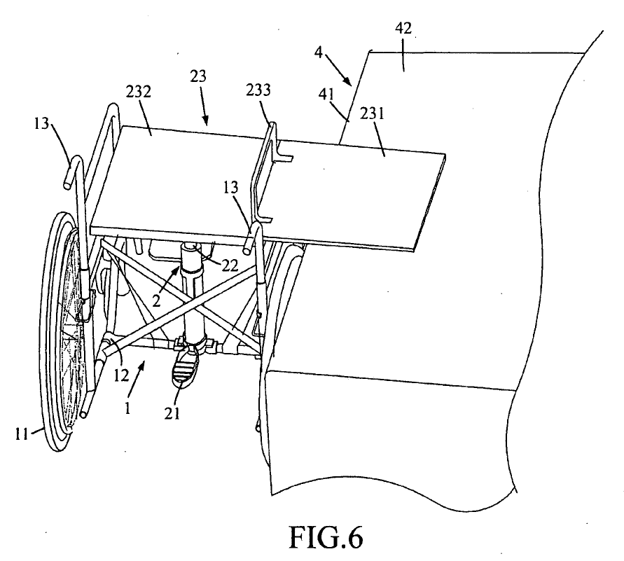

When a disabled person is to be transferred to a bed from a wheelchair via transfer device of the present invention, the following steps are undertaken:
(1) The caregiver holds the handlebars 13 and pushes the wheelchair to the bedside 4, and then operates the shank switch 131 to lower the handlebars 13 to below the bed edge 41, as shown in FIGS. 1-4.
(2) The caregiver pedals the control valve 21 on the bottom of the elevation unit 2 to drive the moving component 22 to raise the seat pad 23 until the seat pad 23 and the bed plane 42 have an identical altitude, as shown in FIGS. 4-5.
(3) The caregiver pulls out the positioning unit 31 from the bottom of the lower seat body 232 and places the positioning unit 31 on the bed plane 42. Simultaneously is pulled out the track levels 32 connecting the positioning unit 31 and the lower seat body 232, as shown in FIG. 5.
(4) The caregiver pulls the upper seat body 231 of the seat pad 23 toward the positioning unit 31 on one side of the track levels 32, as shown in FIG. 5.
(5) When the caregiver moves the upper seat body 231 on to the bed plane 42, the disabled is also moved to on the bed plane 42, as shown in FIGS. 5-6.
(6) The caregiver pushes the upper seat body 231 back to above the lower seat body 232, and pushes the positioning unit 31 back to below the lower seat body 232, as shown in FIGS. 4-5.
(7) The caregiver pedals the control valve 21 on the bottom of the elevation unit 2 to drive the moving component 22 to lower the seat pad 23, as shown in FIGS. 4 and 5.
(8) The caregiver operates the shank switch 131 to restore the handlebars 13 to the original position, as shown in FIGS. 3-4.
(9) The wheelchair is restored to the original status, as shown in FIGS. 1-2.

The present invention enables the caregiver to easily and fast move the disabled person sitting on the wheelchair to another place, whereby the caregiver need not lift the disabled manually and laboriously, and whereby the disabled need not use a walking stick or an auxiliary walking device to support his body and facilitate moving his body.

It should be understood that the embodiments described above are only to exemplify the present invention but not to limit the scope of the present invention, and that any equivalent modification or variation according to the spirit of the present invention is to be also included within the scope of the present invention.

What is claimed is:

1. A wheelchair transfer device allowing a user to move freely and comprising
a base frame, an elevation unit and a transfer unit,
wherein two wheels are arranged on two sides of said base frame; a support structure is arranged in between said two wheels; two auxiliary wheels are arranged on the front side of the base of said support structure; two position-adjustable handlebars are arranged in the back of said support structure, and
wherein said elevation unit is arranged in between said wheels of said base frame and has a moving component able to ascend and descend; a seat pad is arranged on the top of said moving component and has an upper seat body and a lower seat body; a stopper is arranged on one side of said upper seat body, and
wherein said transfer unit is arranged in the bottom of said upper seat body and has a positioning unit; two ends of said positioning unit connect to two track levels, and two casings of said two track levels are fixedly installed inside said lower seat body; said track levels can be pulled out from or pushed into said casings thereof, and said upper seat body can slide on said track levels.

2. The wheelchair transfer device according to claim 1, wherein at least one shank switch is arranged in the middle of said position-adjustable handlebar of said support structure of said base frame and is used to raise or lower said position-adjustable handlebars.

3. The wheelchair transfer device according to claim 1, wherein said elevation unit is a pneumatic cylinder, a hydraulic cylinder, an elevation screw, or a rack-and-pinion mechanism, which is able to raise or lower said moving component.

4. The wheelchair transfer device according to claim 1, wherein said elevation unit has a control valve used to control said moving component to ascend or descend.

5. The wheelchair transfer device according to claim 1, wherein said transfer unit has track levers arranged in the bottom of said lower seat body and can extend out from or retract back to the bottom of said lower seat body.
